(19) United States
(12) Patent Application Publication
(10) Pub. No.: US 2007/0195374 A1
(43) Pub. Date: Aug. 23, 2007

(54) Facsimile machine and client terminal

(75) Inventor: Yoshifumi Tanimoto, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/708,562

(22) Filed: Feb. 21, 2007

(30) Foreign Application Priority Data
Feb. 23, 2006 (JP) 2006-046226

(51) Int. Cl. H04N 1/00

(52) U.S. Cl. 358/400

(57) ABSTRACT

A digital MFP scans a transmission original document, and generates original document image data. A transmission original document generating unit loads information from an information storage medium, generates an information code, and composes the information code with the original document image data. The composed original document image data with the code is transmitted to a facsimile machine of another end. The facsimile machine of the other end prints out the received original document, and after necessary items are written in the printed-out original document, scans a return original document. The return image data is transmitted (returned) to the digital MFP. An image analyzing unit extracts information from the received return image data. An output control unit prints out the return image data when the information stored in the information storage medium coincides with the information extracted from the return image data.

### BACKGROUND OF THE INVENTION

1. Field of the Invention

The present invention relates to technology for distributing an original document received by facsimile (FAX).

2. Description of the Related Art

A conventional facsimile machine includes various distributing functions for sorting received original documents to each person-in-charge. For example, the conventional facsimile machine includes a function for determining a distribution destination according to a facsimile number of a transmitter. In order to use such a function, the facsimile machine stores a distribution setting database, and forwards a received original document to a Personal Computer (PC) of each person-in-charge or forwards via electronic mail according to the distribution setting database.

As described above, received facsimile original documents can be sorted to each person-in-charge by distributing according to a transmitter facsimile number or distributing according to a rule defined in the database.

However, when the received original document is a return original document of the transmitted facsimile, unnecessary distribution may be carried out under the above-mentioned rule. Alternatively, the received original document may not be distributed to a person who should receive the received original document (in this case, a person who has transmitted the facsimile). That is, when one person-in-charge transmits a facsimile and a person who has received the facsimile responds to the facsimile, the person-in-charge who has originally transmitted the facsimile should receive the returned facsimile. A uniform distribution rule registered in the database is insufficient for handling such distribution.

A PC-FAX system is a system in which a facsimile is transmitted and received by a PC via a network. By using a PC-FAX function, without printing a facsimile original document on paper, the facsimile original document can be handled in a form of data. For example, when both a recipient and a transmitter use PC-FAX and all operations for transmission, reception, and return are carried out in a form of data, it would not be difficult to associate a transmitted original document and a received original document. However, when the recipient prints out the received original document on paper, adds a handwritten text to the printed out original document, and returns the original document, it is difficult to associate such an original document with the transmitted original document.

### SUMMARY OF THE INVENTION

In order to overcome the problems described above, preferred embodiments of the present invention provide technology for reliably distributing a received facsimile original document to a person-in-charge, who should be receiving the received facsimile original document, even when a paper medium intervenes, by associating a transmitted original document and the received original document.

According to an aspect of the present invention, a facsimile machine can use a removable information storage medium, and includes a loading unit, an embedding unit, and a transmission unit. The loading unit loads information from the removable information storage medium. The embedding unit converts the information into image data, and embeds the converted image data in original document image data. The transmission unit transmits the original document image data embedding the information by facsimile.

According to another aspect of the present invention, a facsimile machine can use a removable information storage medium, and includes a detecting unit and an output unit. The detecting unit analyzes image data of a received facsimile original document, and detects embedded information. When information loaded from the removable information storage medium coincides with the embedded information, the output unit outputs the received facsimile original document.

According to another aspect of the present invention, a facsimile machine can use a removable information storage medium, and includes a detecting unit, a storage unit, and an output unit. The detecting unit analyzes image data of a received facsimile original document, and detects embedded information. The storage unit associates the embedded information with the received facsimile original document, and stores the embedded information and the received facsimile original document. The output unit loads information from the removable information storage medium when the removable information storage medium is inserted, and outputs a corresponding received facsimile original document when the loaded information coincides with the embedded information.

According to another aspect of the present invention, a facsimile machine connected to a network includes a first detecting unit, a second detecting unit, and a distributing unit. The first detecting unit analyzes image data of a received facsimile original document, and detects embedded information. The second detecting unit detects an information storage medium inserted in a terminal connected via the network. The distributing unit distributes the received facsimile original document to the terminal when the information loaded from the information storage medium coincides with the embedded information.

According to another aspect of the present invention, a facsimile machine connected to a network includes a detecting unit, a storage unit, and a distributing unit. The detecting unit analyzes image data of a received facsimile original document, and detects embedded information. The storage unit associates the embedded information and the received facsimile original document, and stores the embedded information and the received facsimile original document. When detecting the information storage medium inserted in a terminal connected via the network, the distributing unit loads information from the information storage medium. Then, when the loaded information coincides with the embedded information, the distributing unit distributes a corresponding received facsimile original document to the terminal.

According to another aspect of the present invention, a client terminal is connected to a network and can use a removable information storage medium. The client terminal includes a loading unit, an embedding unit, and an instruction unit. The loading unit loads information from the removable information storage medium. The embedding unit converts the information into image data, and embeds the converted image data in original document image data. The instruction unit forwards the original document image data embedded with the information to a facsimile machine via the network, and carries out a facsimile transmission instruction.

The facsimile machine of the present invention converts the information loaded from the removable storage medium into image data, embeds the converted image data in the original document image data, and transmits the original document image data embedded with information by facsimile. Accordingly, even when the facsimile machine or the like that has received the transmission original document prints out the received original document, the information is displayed as an image on a printed-out medium. Thus, information at transmission can also be recorded on a printed-put medium.

For example, after a facsimile original document is printed out at a recipient, even when such a printed-out medium is returned, the printed-out medium can be associated with the information at transmission.

The facsimile machine of the present invention analyzes the image data of the received facsimile original document, and detects the embedded information. When the embedded information coincides with the information loaded from the information storage medium, the facsimile machine prints out the received facsimile original document. The received original document is printed out only when the information storage medium storing information that is the same as the embedded information is detected. Accordingly, the received original document is not output when a person who should be receiving such an original document is absent. The person who should be receiving the original document can reliably receive the received original document.

The facsimile machine of the present invention analyzes the image data of the received facsimile original document, and detects the embedded information. When the embedded information coincides with the information loaded from the information storage medium inserted in the terminal on the network, the facsimile machine distributes the received facsimile original document to such a terminal. Accordingly, even when a person who should be receiving a return facsimile is located at a position different from where the facsimile machine that has transmitted the facsimile is located, the received facsimile can be directly delivered to the person who should be receiving such a return facsimile. The facsimile machine of the present invention is convenient even when a position where a facsimile is transmitted is different from a position where a return facsimile is to be received.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates a facsimile system including a digital Multi Function Peripheral (MFP) according to a preferred embodiment of the present invention.

FIG. 2 is a functional block diagram of a digital MFP, a facsimile machine, and a PC.

FIG. 3 is a flowchart illustrating a processing carried out when transmitting a facsimile by a digital MFP.

FIG. 4 is a flowchart illustrating a processing carried out when receiving a facsimile by a digital MFP.

FIG. 5 is a flowchart illustrating a processing carried out by a digital MFP when an information storage medium is detected.

### DETAILED DESCRIPTION OF PREFERRED EMBODIMENTS

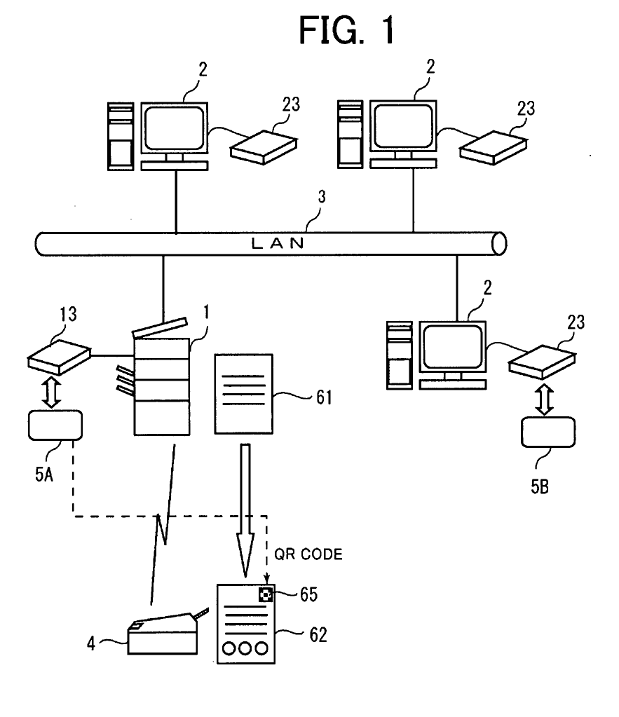

In the following, a description will be made of preferred embodiments of the present invention with reference to the accompanying drawings. FIG. 1 illustrates a network configuration in an office. A Local Area Network (LAN) 3 is constructed in an office. A digital MFP 1 and a plurality of personal computers 2 (hereinafter referred to as a “PC 2”) are connected to the LAN 3.

The digital MFP 1 includes a copier function, a facsimile function, a printer function, and a scanner function or the like, and also includes a network function. Therefore, the PC 2 connected to the LAN 3 can use various functions of the digital MFP 1 via the LAN 3. Workers working in the office share one digital MFP 1. A worker may use the digital MFP 1 via the LAN 3 by operating the PC 2. Alternatively, a worker may actually move to the digital MFP 1, and carry out a facsimile operation or a copying operation at the digital MFP 1.

A facsimile original document transmitted from the digital MFP 1 is received via another facsimile machine 4 via a Public Switched Telephone Network (PSTN). The facsimile machine 4 may be located at a remote location, or may be located within the same building as the digital MFP 1. The facsimile machine 4 prints out the received facsimile original document. In the present preferred embodiment, the facsimile original document transmitted from the digital MFP 1 is associated with the facsimile original document returned from the facsimile machine 4. That is, according to facsimile transmission technology of a preferred embodiment of the present invention, when a facsimile original document is returned after characters and/or text is written in the facsimile original document printed out by the facsimile machine 4, the facsimile original document transmitted first may be associated with the returned facsimile original document.

As described above, the present preferred embodiment is described with reference to an example in which the facsimile machine 4 returns a facsimile original document (image data), that is, the facsimile machine 4 returns a facsimile original document (image data) by G3 facsimile (T.30) using the PSTN. However, the present invention is substantially applicable to all systems that can transmit and receive image data. For example, the present invention is applicable to facsimile communication (T.37 and T.38) using the Internet, and transmission and reception of image data using protocols such as a Hyper Text Transfer Protocol (HTTP) and a File Transfer Protocol (FTP).

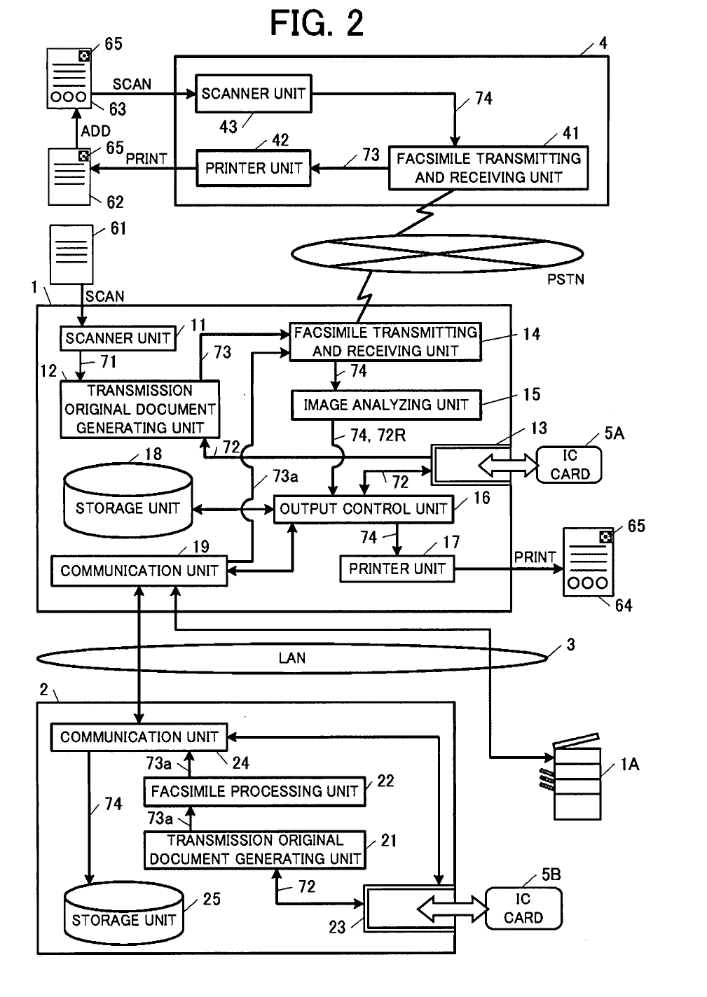

FIG. 2 is a functional block diagram of the digital MFP 1, the PC 2, and the facsimile machine 4. As illustrated in FIG. 2, the digital MFP 1 includes a scanner unit 11, a transmission original document generating unit 12, a reading device 13, a facsimile transmitting and receiving unit 14, an image analyzing unit 15, an output control unit 16, a printer unit 17, a storage unit 18, and a communication unit 19.

The scanner unit 11 scans a transmission original document 61 such as text, documentation, and drawings to generate original document image data 71. The transmission original document generating unit 12 generates original document image data with a code 73 to be described hereinafter in accordance with the original document image data 71 scanned by the scanner unit 11.

The reading device 13 reads an information storage medium 5A. The reading device 13 may be an external device to be connected to the digital MFP 1 as illustrated in FIG. 1. Alternatively, the reading device 13 may be included in the digital MFP 1. For example, when the information storage medium 5A is an Integrated Circuit (IC) card, the reading device 13 is an IC card reader. A Universal Serial Bus (USB) interface may be used for connecting the information storage medium 5A and the reading device 13. Further, the information storage medium inserted in the digital MFP 1 is represented by reference numeral 5A, and the information storage medium inserted in the PC 2 is represented by reference numeral 5B. Although a distinction is made, there is no substantial difference between the information storage mediums 5A and 5B. When no distinction is to be made, the information storage mediums 5A and 5B will simply be referred to as an information storage medium 5.

The transmission original document generating unit 12 includes a function for loading information 72 stored in the information storage medium 5A and generating image data of code information from the information 72, and a function for embedding the code information in the original document image data 71. The original document image data 71 embedded with the code information (information 72 in the form of the image data) is the original document image data with the code 73.

For example, as illustrated in FIG. 1, the information 72 in the form of the image data is embedded in the transmission original document 61 loaded from the scanner unit 11. Then, the original document image data with the code 73 is transmitted to the facsimile machine 4. The facsimile machine 4 receives the original document image data with the code 73, and prints out a received original document 62. Further, in the present preferred embodiment, a Quick Response (QR) code 65 is used as code information. A form of the code information is not limited in particular. The code information may be a two-dimensional barcode other than the QR code.

The facsimile transmitting and receiving unit 14 transmits the original document image data with the code 73 to the facsimile machine 4 via the PSTN.

As illustrated in FIG. 2, the facsimile machine 4 includes a facsimile transmitting and receiving unit 41, a printer unit 42, and a scanner unit 43. The facsimile transmitting and receiving unit 41 receives the original document image data with the code 73 transmitted from the digital MFP 1. The printer unit 42 prints out the received original document image data with the code 73 as the received original document 62. As illustrated in the drawings, the QR code 65 is printed on the received original document 62 in addition to the text of the original document.

A person-in-charge who has received the received original document 62 uses a pen or a pencil, etc. to write characters in the received original document 62. For example, when the received original document 62 is an application form for participating in a seminar, a person-in-charge writes name and a telephone number in the received original document 62. Alternatively, when the received original document 62 is an application form for purchasing a campaigned product, a person-in-charge writes name, number of purchases, and purchased price, etc. in the received original document 62.

After the person-in-charge writes necessary information in the received original document 62, the person-in-charge returns the received original document 62 as a return original document 63 from the facsimile machine 4. Therefore, the QR code 65 is printed on the return original document 63. Specifically, the person-in-charge scans the return original document 63 using the scanner unit 43 of the facsimile machine 4, enters a destination facsimile number, and transmits (returns) a facsimile. The scanner unit 43 scans the return original document 63, and generates return image data 74. The facsimile transmitting and receiving unit 41 transmits (returns) the return image data 74 to the digital MFP 1.

The facsimile transmitting and receiving unit 14 of the digital MFP 1 receives the return image data 74 transmitted from the facsimile machine 4. The image analyzing unit 15 includes a function for analyzing the return image data 74 received by the facsimile transmitting and receiving unit 14 and detecting code information. For example, by embedding a specific image pattern in the code information, the image analyzing unit 15 can detect the code information. The image analyzing unit 15 includes a function for converting the code information to restore the original information 72. The image analyzing unit 15 provides the return image data 74 and the extracted information 72 to the output control unit 16. In the following description, to facilitate the description, the information 72 extracted from the return image data 74 will be referred to as information 72R and distinguished from information 72 embedded at transmission or information 72 stored in the information storage medium 5.

The output control unit 16 accesses the reading device 13, and confirms whether or not the information storage medium 5A is inserted. When the information storage medium 5A is inserted, the output control unit 16 confirms whether or not the information 72 is stored. When the information 72 is detected from the information storage medium 5A, the output control unit 16 compares the information 72 stored in the information storage medium 5A with the information 72R extracted from the return image data 74. When the information 72 stored in the information storage medium 5A coincides with the information 72R extracted from the return image data 74, the output control unit 16 controls to print out the return image data 74 as the return original document 64 from the printer unit 17. The QR code 65 is also printed on the return original document 64.

When the information 72 is not detected from the information storage medium 5A, the output control unit 16 associates the information 72R extracted from the return image data 74 with the return image data 74, and stores the information 72R and the return image data 74 in the storage unit 18.

The output control unit 16 accesses the PC 2 via the LAN 3, and confirms whether or not the information storage medium 5B is inserted in a reading device 23 of the PC 2. When the information storage medium 5B is inserted, the output control unit 16 confirms whether or not the information 72 is stored in the information storage medium 5B. When the information 72 is detected from the information storage medium 5B via the LAN 3, the output control unit 16 compares the information 72 stored in the information storage medium 5B with the information 72R detected from the return image data 74. When the information 72 stored in the information storage medium 5B coincides with the information 72R detected from the return image data 74, the output control unit 16 forwards the return image data 74 to the PC 2.

The PC 2 includes a transmission original document generating unit 21, a facsimile processing unit 22, a reading device 23, a communication unit 24, and a storage unit 25. The PC 2 is a client terminal which can execute a so-called PC-FAX function. That is, without printing an original document created by a word processor or the like of the PC 2 onto a paper medium, the original document can be transmitted by facsimile via the digital MFP 1.

The transmission original document generating unit 21 is a processing unit for transmitting original document image data with a code 73a by PC-FAX transmission. Specifically, the transmission original document generating unit 21 includes a function for converting an original document text, a drawing, and/or a documentation or the like generated by a word processor software or the like into image data. The transmission original document generating unit 21 also includes a function for generating the original document image data with the code 73a by loading the information 72 from the information storage medium 5B inserted in the reading device 23, converting the information 72 into image data and embedding the converted image data in the original document image data.

The facsimile processing unit 22 is a processing unit for carrying out PC-FAX transmission of the original document image data with the code 73a. The original document image data with the code 73a output from the facsimile processing unit 22 is forwarded to the digital MFP 1 by the communication unit 24. The facsimile transmitting and receiving unit 14 of the digital MFP 1 transmits the original document image data with the code 73a, which has been received from the PC 2, to facsimile machine 4. A processing carried out after the facsimile machine 4 receives the original document image data with the code 73a is the same as the processing carried out when receiving the original document image data with the code 73. Thus, a detailed description will be omitted. Briefly, the original document image data with the code 73a is printed out as the received original document 62, and a person-in-charge writes necessary information in the received original document 62. Then, the return original document 63 is scanned, and returned as the return image data 74 to the digital MFP 1.

A description has been made of an example in which the return image data 74 is distributed to the PC 2 when the output control unit 16 of the digital MFP 1 detects the information 72 from the information storage medium 5B inserted in the PC 2. The return image data 74 distributed to the PC 2 is stored in the storage unit 25.

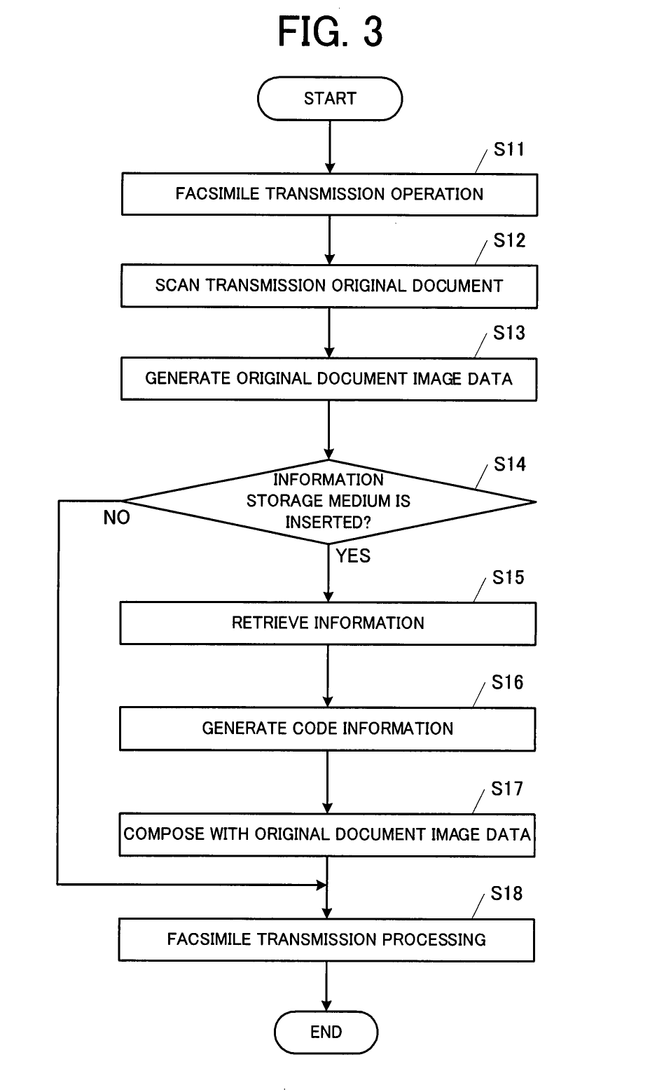

Next, with reference to the flowcharts of FIG. 3 through FIG. 5, a description will be made of a processing flow for transmitting and receiving a facsimile in the above-described system configuration according to the present preferred embodiment of the present invention.

First, with reference to FIG. 3, a description will be made of a flow of processing carried out when transmitting a facsimile. A person-in-charge who has created the transmission original document 61 illustrated in FIG. 2 carries out a facsimile transmission operation at the digital MFP 1 (step S11). Accordingly, the scanner unit 11 scans the transmission original document 61 (step S12), and generates the original document image data 71 (step S13).

Next, the transmission original document generating unit 12 accesses the reading device 13, and confirms whether or not the information storage medium 5A is inserted (step S14). When the information storage medium 5A is not inserted (step S14: NO), the facsimile transmission is executed (step S18). That is, general facsimile transmission is carried out.

When the information storage medium 5A is inserted (step S14: YES), the information 72 is retrieved from the information storage medium 5A (step S15), and code information is generated (step S16). For example, the transmission original document generating unit 12 retrieves the information 72 from an IC card inserted in an IC card reader, and generates code information (QR code 65).

Next, the transmission original document generating unit 12 composes the code information with the original document image data 71 to generate the original document image data with the code 73 (step S17). Then, the facsimile transmitting and receiving unit 14 transmits the original document image data with the code 73 to another facsimile machine 4.

The facsimile transmission processing in the digital MFP 1 ends by the above-described processing. The code information is embedded in the facsimile transmission image transmitted as described above. The code information has been generated according to the information 72 stored in the information storage medium 5A. Therefore, when the information storage medium 5A is an IC card distributed to each employee and the information 72 is information identifying an individual employee, the information 72 that identifies each employee is embedded as an image in the facsimile transmission image. Accordingly, even when the facsimile transmission image is transmitted to another facsimile machine 4 and printed out, the information 72 is printed as the code information (as an image) on the output paper medium. This enables a transmitted original document to be traced. In order to embed the information 72, a person-in-charge who transmits a facsimile may just insert the information storage medium 5A in the reading device 13. A troublesome setting operation or the like is not required.

Further, when carrying out PC-FAX transmission from the PC 2, the transmission original document generating unit 21 loads the information 72 stored in the information storage medium 5B, generates the code information in the same manner as described above, and composes the code information with the original document image data. The original document image data with the code 73a generated as described above is transmitted to another facsimile machine 4 via the digital MFP 1. For example, when the information 72 that identifies an employee is embedded as an image in the facsimile image transmitted by PC-FAX from the PC 2, it is possible to trace the transmitted original document. Also in case of this method, when a person-in-charge operates the PC 2 to execute a PC-FAX operation, it is just necessary to insert the information storage medium 5B, and a troublesome work is unnecessary.

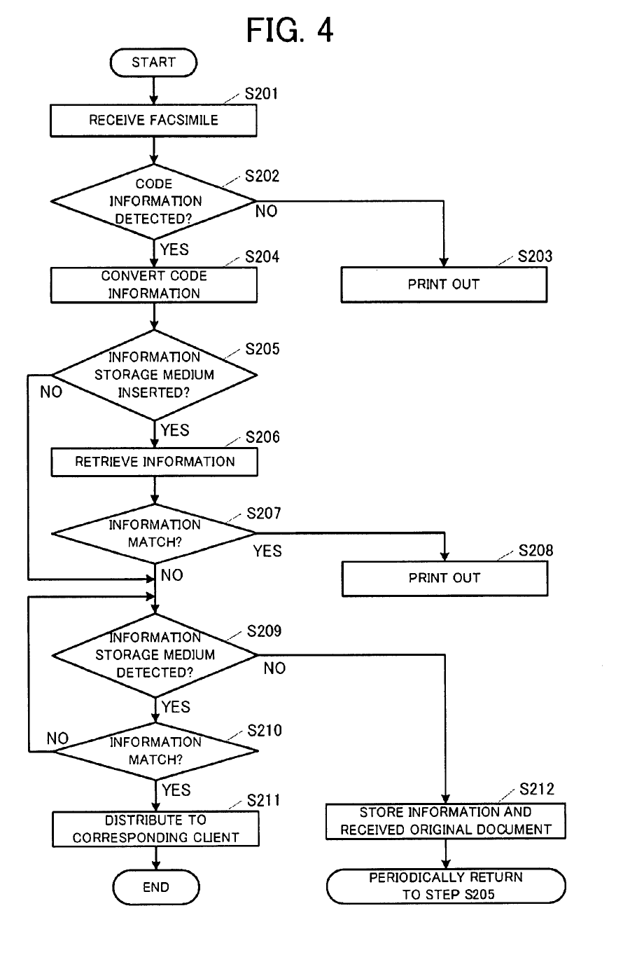

Next, with reference to FIG. 4, a description will be made of a flow of processing carried out when receiving a facsimile. First, the facsimile transmitting and receiving unit 14 of the digital MFP 1 carries out a facsimile reception (step S201). Next, the image analyzing unit 15 detects code information from the received facsimile image (step S202). When code information is not detected from the facsimile image (step S202: NO), the output control unit 16 instructs the printer unit 17 to output the received original document. Accordingly, a printing operation is carried out (step S203). This printing operation is carried out when code information is not embedded in the received facsimile image. Thus, this printing operation is a portion of general facsimile reception processing.

When the code information is detected from the received facsimile image (step S202: YES), the image analyzing unit 15 converts the code information to restore the information 72R (step S204). When the code information is detected, the received facsimile image is the return image data 74. Therefore, in the following description, the received facsimile image is described as the return image data 74. In this case, the image analyzing unit 15 restores the information 72 from the code information embedded in the return image data 74. Further, the code information has been generated originally from the information 72.

The output control unit 16 receives the return image data 74 and the information 72R from the image analyzing unit 15. The output control unit 16 accesses the reading device 13, and confirms whether or not the information storage medium 5A is inserted (step S205). When the information storage medium 5A is not detected, the process proceeds onto step S209.

When the information storage medium 5A is detected (step S205: YES), the output control unit 16 reads the information 72 from the information storage medium 5A (step S206). The image analyzing unit 15 determines whether or not the information 72R extracted from the return image data 74 coincides with the information 72 stored in the information storage medium 5A (step S207). When the information 72R extracted from the return image data 74 coincides with the information 72 stored in the information storage medium 5A, the return image data 74 is printed out (step S208). That is, since the information storage medium 5A storing the information 72 that is the same as the information 72R embedded in the return image data 74 is detected, a determination is made that a person-in-charge who should be receiving the return image data 74 has been authenticated, and the return image data 74 is printed out. Accordingly, the return facsimile can be received reliably by a person-in-charge possessing the same information storage medium 5A as at transmission. Conversely, unless a person-in-charge who has transmitted the original facsimile inserts the information storage medium 5A of himself or herself in the reading device 13, the digital MFP 1 does not print out the return facsimile. Therefore, the return facsimile is not lost by being printed out when the person-in-charge is not aware of the return facsimile. The return facsimile can be received directly by the person-in-charge who should be receiving the return facsimile. As a result, work efficiency can be improved.

When the information 72R does not coincide with the information 72 at step S207, that is, when the information storage medium 5A is inserted but the inserted information storage medium 5A is different from the information storage medium 5A inserted at transmission, a determination is carried out as to whether or not the information storage medium 5B is inserted in the PC 2 connected via the LAN 3 (step S209). That is, the output control unit 16 carries out communication with the PC 2 via the communication unit 19, and confirms whether or not the information storage medium 5B is inserted in the reading device 23 of the PC 2.

When the information storage medium 5B is inserted (step S209: YES), the information 72 stored in the information storage medium 5B is acquired, and the information 72 is compared with the information 72R extracted from the return image data 74 (step S210). When the information 72 coincides with the information 72R, the digital MFP 1 forwards (distributes) the return image data 74 to the PC 2 inserted with the information storage medium 5B (step S211).

In the PC 2, the communication unit 24 receives the return image data 74, and the return image data 74 is stored in the storage unit 25. As described above, when the information storage medium 5 used for embedding the code information at facsimile transmission is detected in the PC 2 connected to the digital MFP 1 via the network, the return image data 74 is forwarded to such PC 2. That is, even when a person-in-charge who should be receiving the return image data 74 is located at a position different from a position where a device or a terminal that has carried out the facsimile transmission is located, the return image data 74 is forwarded to the terminal in which the information storage medium 5 of such person-in-charge is detected. Accordingly, if the digital MFP 1 can detect the information storage medium 5 inserted in a terminal, the person-in-charge who has transmitted the facsimile can reliably receive the return facsimile at such a terminal. It is extremely convenient when the person-in-charge wishes to receive the return original document at a location different from where the person-in-charge has transmitted the facsimile.

Further, in the above-described preferred embodiment, the return image data 74 is forwarded to the PC 2 connected to the network. The terminal of the forwarding destination is not limited to the PC, and may be a facsimile machine or the like. For example, as illustrated in FIG. 2, suppose that another digital MFP 1A is connected to the LAN 3. When the information storage medium 5 is inserted in the digital MFP 1A and the information 72 is detected, the return image data 74 is forwarded to the digital MFP 1A. Accordingly, the digital MFP 1A can print out the received return image data 74. As described above, by inserting the information storage medium 5 in the digital MFP 1 or 1A that is located close to the user, the user can receive a facsimile at a position closest to the user. That is, when the digital MFP 1 of the present preferred embodiment includes the same role and function as the PC 2 of the present preferred embodiment, and a plurality of such digital MFPs 1 are connected to the network, regardless of from which MFP the user has transmitted the facsimile, the user can freely select another MFP for receiving the facsimile.

When the information storage medium 5B is detected on the network at step S209, the output control unit 16 associates the return image data 74 with the extracted information 72R, and stores the return image data 74 and the extracted information 72R in the storage unit 18 (step S212).

The return image data 74 and the information 72R are stored in the storage unit 18 at step S212 because the information 72 that coincides with the information 72 R extracted from the return image data 74 is not detected from the reading device 13 of the digital MFP 1 or the reading device 23 on the network. That is, at the present moment, since the person-in-charge who has transmitted the original facsimile has not inserted the information storage medium 5 in any terminal, the facsimile is stored in the storage unit 18 without printing out or forwarding the received facsimile. Then, after a prescribed interval, the output control unit 16 returns to step S205 and repeats the processing. That is, the processing is repeated until the received facsimile is printed out at step S208 or forwarded at step S211. Accordingly, even when the person-in-charge who has transmitted the original facsimile is absent at a point of time when receiving the return original document data 74, the person-in-charge may insert the information storage medium 5 in the digital MFP 1 or the PC 2 later, and the received facsimile can be printed out or forwarded.

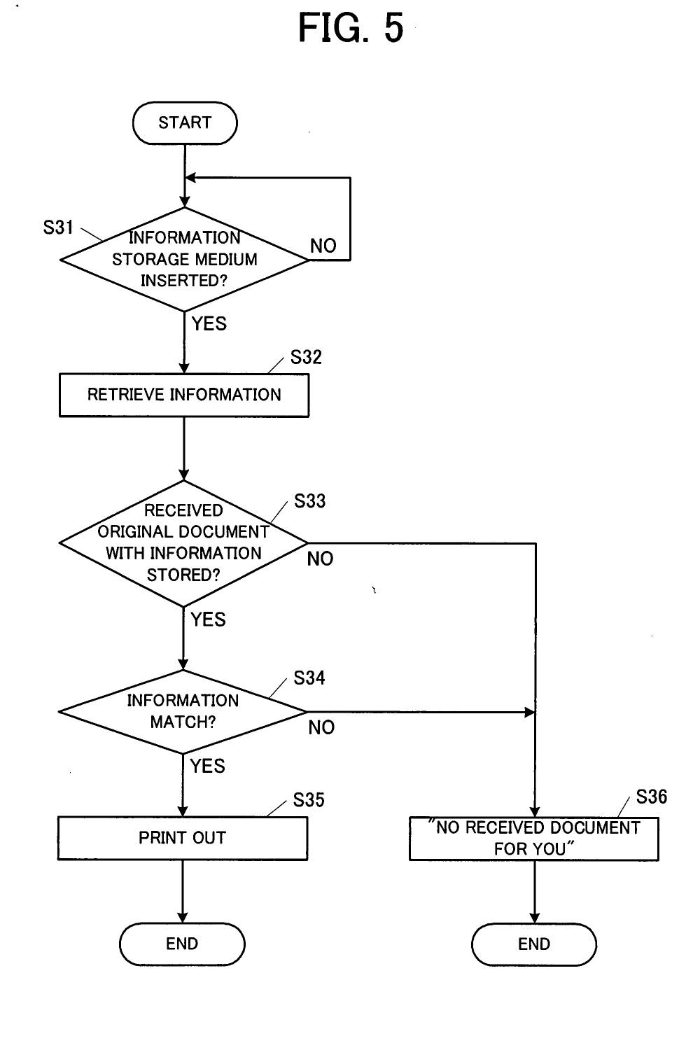

FIG. 5 is a flowchart illustrating a processing carried out when the information storage medium 5A is inserted in the digital MFP 1. When the output control unit 16 detects that the information storage medium 5A is inserted in the reading device 13 (step S31: YES), the information 72 is retrieved from the information storage medium 5A (step S32). Then, a determination is carried out as to whether or not the return image data 74 associated with the information 72R is stored in the storage unit 18 (step S33). When the data is not stored (step S33: NO), a display of the digital MFP 1 displays a message “No received document for you.” (step S36) That is, when the user wishes to confirm whether or not a return facsimile addressed to the user has been received, the user may insert the information storage medium 5A in the digital MFP 1.

When it is detected at step S33 that the return image data 74 associated with the information 72R is stored in the storage unit 18, a confirmation is carried out as to whether or not the information 72 stored in the information storage medium 5A coincides with the information 72R stored in the storage unit 18 (step S34). When the information 72 and the information 72R coincide, the printer unit 17 prints out the return image data 74 (step S35). When the information 72 does not coincide with the information 72R, the process proceeds onto step S36 and the message is displayed.

Accordingly, when the digital MFP 1 receives the return image data 74, even when the person-in-charge who has transmitted an original facsimile is out of office or attending a meeting, after the person-in-charge returns to the office and inserts the information storage medium 5A in the digital MFP 1, the return facsimile can be output. The received facsimile is not output during an absence of the person-in-charge, and the person-in-charge can reliably receive the facsimile original document.

Further, also in the flowchart of FIG. 4, the processing of step S205 and onward is repeated. Therefore, at a point of time when the information storage medium 5 is inserted or detected, the return image data 74 is output or forwarded. The processing illustrated in FIG. 4 is executed at facsimile reception. The processing illustrated in FIG. 5 has significance that even when a facsimile has not been received, at step S36, a notification is carried out to the person-in-charge that there is no document received.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A facsimile machine, which can use a removable information storage medium, the facsimile machine comprising:
a loading unit which loads information from the removable information storage medium;
an embedding unit which converts the information into image data and embeds the image data in original document image data; and
a transmission unit which transmits the original document image data embedded with the information by facsimile.

2. The facsimile machine according to claim 1, wherein the information storage medium is an integrated circuit card.

3. The facsimile machine according to claim 1, wherein the information is converted into the image data by a two-dimensional barcode.

4. A facsimile machine, which can use a removable information storage medium, the facsimile machine comprising:
a detecting unit which analyzes image data of a received facsimile original document and detects embedded information; and
an output unit which outputs the received facsimile original document when information loaded from the removable information storage medium coincides with the embedded information.

5. The facsimile machine according to claim 4, wherein the information storage medium is an integrated circuit card.

6. The facsimile machine according to claim 4, wherein the embedded information is converted into the image data by a two-dimensional barcode.

7. The facsimile machine according to claim 4, further comprising a storage unit which stores the received facsimile original document when the information loaded from the removable information storage medium does not coincide with the embedded information.

8. A facsimile machine, which can use a removable information storage medium, the facsimile machine comprising:
a detecting unit which analyzes image data of a received facsimile original document and detects embedded information;
a storage unit which associates the embedded information and the received facsimile original document, and stores the embedded information and the received facsimile original document; and
an output unit which loads information from the removable information storage medium when the removable information storage medium is inserted, and when the loaded information coincides with the embedded information, outputs a corresponding received facsimile original document.

9. A facsimile machine connected to a network, the facsimile machine comprising:
a first detecting unit which analyzes image data of a received facsimile original document and detects embedded information;
a second detecting unit which detects an information storage medium inserted in a terminal connected via the network; and
a forwarding unit which forwards the received facsimile original document to the terminal when information loaded from the information storage medium coincides with the embedded information.

10. A facsimile machine connected to a network, the facsimile machine comprising:
a detecting unit which analyzes image data of a received facsimile original document and detects embedded information;
a storage unit which associates the embedded information and the received facsimile original document, and stores the embedded information and the received facsimile original document; and
a forwarding unit, wherein when detecting an information storage medium inserted in a terminal connected via the network, the forwarding unit loads information from the information storage medium, and when the loaded information coincides with the embedded information, the forwarding unit forwards a corresponding received facsimile original document to the terminal.

11. A client terminal, which is connected to a network and can use a removable information storage medium, the client terminal comprising:
a loading unit which loads information from the removable information storage medium;
an embedding unit which converts the information into image data and embeds the image data in original document image data; and
an instruction unit which forwards the original document image data embedded with the information to a facsimile machine via the network, and carries out a facsimile transmission instruction.
